(19) United States
(12) Patent Application Publication
(10) Pub. No.: US 2013/0141369 A1
(43) Pub. Date: Jun. 6, 2013

(54) SYSTEMS FOR DISPLAYING IMAGES

(71) Applicants: Innocom Technology (Shenzhen) Co., Ltd., Shenzhen City (CN); CHIMEI INNOLUX CORPORATION, Chu-Nan (TW)

(72) Inventor: Kung-Chieh HUANG, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/687,539

(22) Filed: Nov. 28, 2012

(30) Foreign Application Priority Data
Dec. 5, 2011 (TW) 100144600

(51) Int. Cl. G06F 3/041

(52) U.S. Cl. CPC G06F 3/041
USPC 345/173

(57) ABSTRACT

A system for displaying images is provided. The system includes a touch sensor device including a substrate having a sensing region. The sensing region includes a central portion. A sensing electrode layer is disposed on the substrate in the sensing region and includes a plurality of sensing electrode patterns corresponding to the central portion. Each sensing electrode pattern includes at least one non-linear edge, such that the adjacent sensing electrode patterns are wedged with each other.

### CROSS REFERENCE TO RELATED APPLICATIONS

This application claims priority of Taiwan Patent Application No. 100144600, filed on Dec. 5, 2011, the entirety of which is incorporated by reference herein.

### BACKGROUND OF THE INVENTION

1. Field of the Invention

The invention relates to touch panel display technologies, and in particular to a sensing electrode structure of a touch sensor device for a touch panel display.

2. Description of the Related Art

A touch sensor device is typically integrated with a flat panel display device (such as an LCD, AMOLED or the like) to form a touch panel display. Touch panel displays are typically used in electronic devices, such as portable personal computers, personal digital assistants (PDAs), electronic books, projectors, mobile phones, and the like. The touch panel display is capable of conducting input functions by a finger, a stylus, a pen, or the like and therefore has gained an increasing amount of attention and popularity.

Recently, a co-plane single-layer touch sensor device, in which a sensing electrode array is formed on one side of the substrate and each sensing electrode is individually connected to one trace, has been developed in order to reduce the manufacturing cost of the touch sensor device. Referring to FIG. 1, which illustrates a plan view of a conventional co-plane single-layer touch sensor device. The touch sensor device 20 includes a transparent substrate 10 and a sensing electrode array formed thereon. The sensing electrode array is formed by patterning a transparent conductive layer, such as indium tin oxide (ITO), and includes a plurality of triangular sensing electrode patterns 12 in an interlaced arrangement. Moreover, each triangular sensing electrode pattern 12 is individually connected to a trace 14. Such a touch sensor device 20, however, has sensing electrodes with poor linearity and is only used in a single touch operation.

Referring to FIG. 2, which illustrates a plan view of another conventional co-plane single-layer touch sensor device. The touch sensor device 40 includes a transparent substrate 30 and a sensing electrode array (which is formed of ITO) formed thereon. The sensing electrode array includes a plurality of diamond sensing electrode patterns 32 in an interlaced arrangement and a plurality of triangular sensing electrode patterns 34 disposed around the plurality of diamond sensing electrode patterns 32. Also, each diamond sensing electrode pattern 32 and each triangular sensing electrode pattern 34 are individually connected to a trace (not shown), wherein each trace (which is formed of ITO) is extended to the outside of the sensing electrode array through the groove g between the diamond sensing electrode patterns 32 and between the diamond sensing electrode pattern 32 and the triangular sensing electrode pattern 34. Such a touch sensor device 40 can be used in multi-touch operations and the linearity of the sensing electrode can be improved by reducing the areas of the diamond sensing electrode pattern 32 and the triangular sensing electrode pattern 34. However, the amount of the traces disposed in the grooves g must be increased due to the reduction of the sensing electrode pattern area, thereby increasing the difficulty for routing.

Accordingly, there exists a need in the art for development of a touch sensor device structure, capable of mitigating or eliminating the aforementioned problems.

### BRIEF SUMMARY OF THE INVENTION

A detailed description is given in the following embodiments with reference to the accompanying drawings. Systems for displaying images are provided. An exemplary embodiment of a system for displaying images comprises a touch sensor device comprising a substrate having a sensing region. The sensing region comprises a central portion. A sensing electrode layer is disposed on the substrate in the sensing region and includes a plurality of sensing electrode patterns corresponding to the central portion. Each sensing electrode pattern comprises at least one non-linear edge, such that the adjacent sensing electrode patterns are wedged with each other.

### BRIEF DESCRIPTION OF DRAWINGS

The invention can be more fully understood by reading the subsequent detailed description and examples with references made to the accompanying drawings, wherein:

FIG. 1 is a plan view of a conventional co-plane single-layer touch sensor device;

FIG. 2 is a plan view of another conventional co-plane single-layer touch sensor device;

FIG. 3 is a plan view of an embodiment of a system for displaying images including a co-plane single-layer touch sensor device according to the invention;

FIG. 4 is a plan view of a substrate in the touch sensor device shown in FIG. 3;

FIG. 5A is a plan view of a first sensing electrode pattern shown in FIG. 3;

FIG. 5B is a plan view of a second sensing electrode pattern shown in FIG. 3;

FIG. 5C is a plan view of a third sensing electrode pattern shown in FIG. 3;

FIG. 6A is an enlarged plan view of the region A shown in FIG. 3;

FIG. 6B is an enlarged plan view of the region B shown in FIG. 3; and

FIG. 7 schematically shows another embodiment of a system for displaying images.

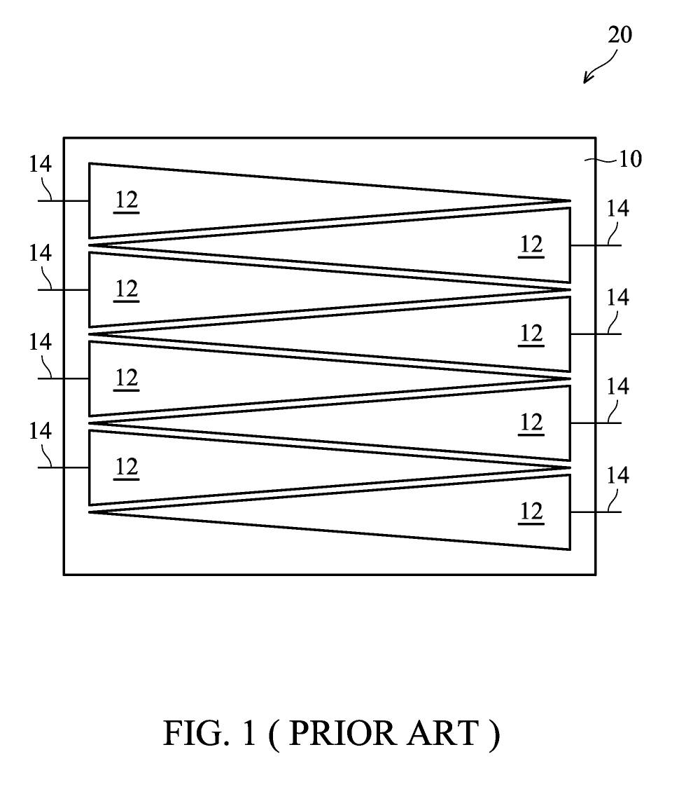

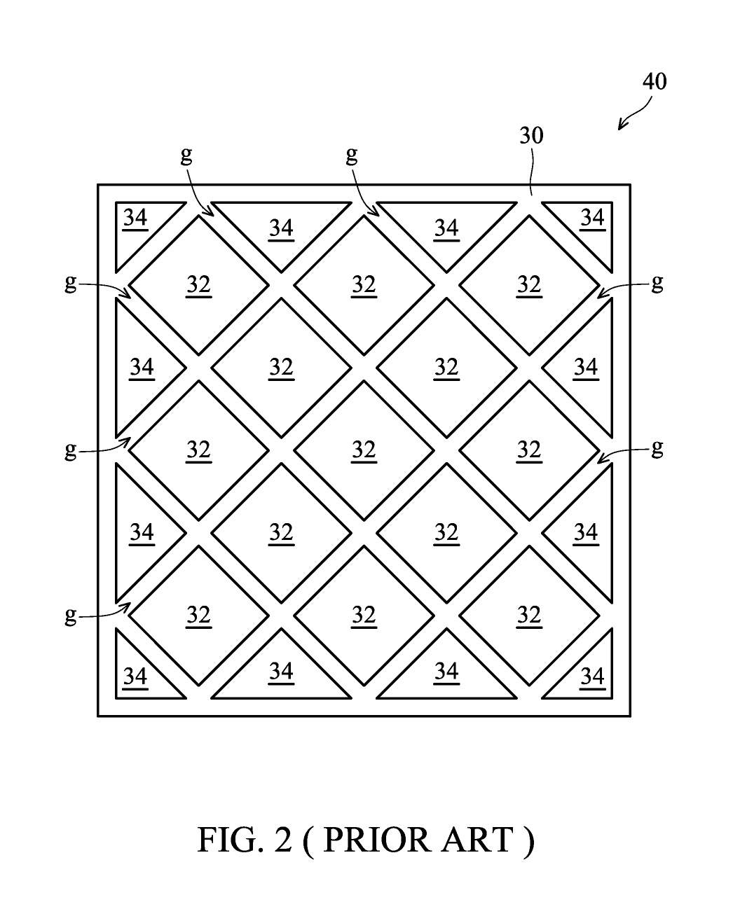

### DETAILED DESCRIPTION OF INVENTION

The following description is of the best-contemplated mode of carrying out the invention. This description is provided for the purpose of illustrating the general principles of the invention and should not be taken in a limiting sense. The scope of the invention is best determined by reference to the appended claims.

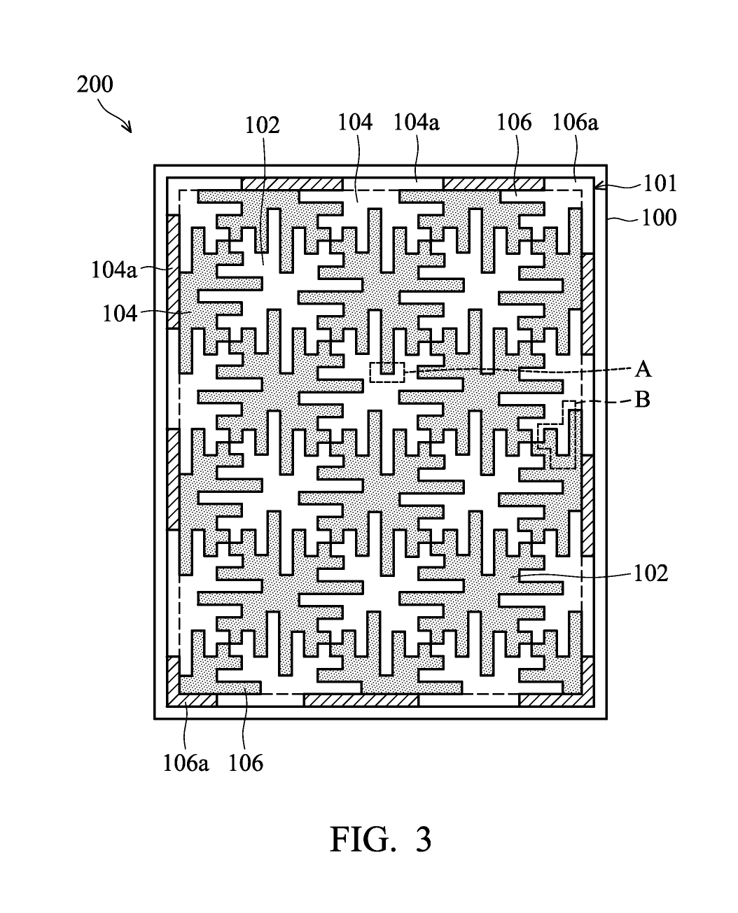

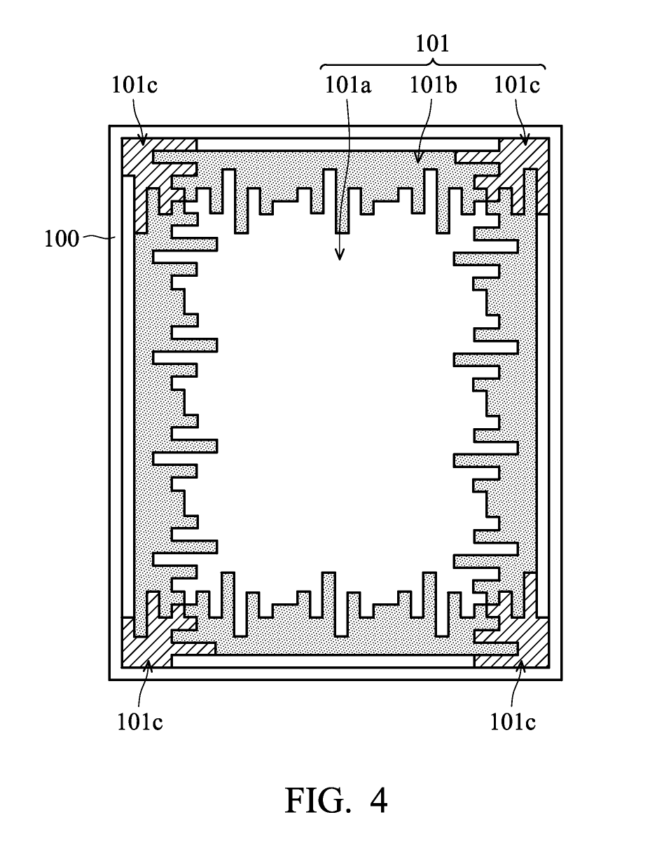

Systems for displaying images are provided. Refer to FIG. 3, in which a plan view of an embodiment of a system for displaying images including a co-plane single-layer touch sensor device is shown according to the invention. In the embodiment, the touch sensor device 200 comprises a substrate 100 and a sensing electrode layer disposed on the substrate 100. The substrate 100 may be comprised of glass, quartz, or other flexible or inflexible polymer transparent materials, and is used for providing a touch sensing surface and a carrier substrate of the touch sensor device. Referring to FIG. 4, which is a plan view of the substrate 100 in the touch sensor device 200 shown in FIG. 3. In the embodiment, the substrate 100 has a sensing region 101 comprising a central portion 101a and a peripheral portion, wherein the central portion 101a is surrounded by the peripheral portion. In one embodiment, the sensing region 101 is rectangular, and the peripheral portion of the sensing region 101 comprises a plurality of peripheral edge portions 101b and a plurality of peripheral corner portions 101c, such that the central portion 101a is surrounded by the pluralities of peripheral edge portions 101b and peripheral corner portions 101c.

Referring to FIG. 3 again, the sensing electrode layer is disposed on the substrate 100 in the sensing region 101. In one embodiment, the sensing electrode layer is formed by patterning a metal mesh layer, which is formed of, but not limited to copper, aluminum, molybdenum, an alloy thereof or a combination thereof. The sensing electrode layer may comprise a plurality of first sensing electrode patterns 102 electrically insulated from each other and corresponding to the central portion 101a (which is shown in FIG. 4) of the sensing region 101. Particularly, in the embodiment, each first sensing electrode pattern 102 has at least one non-linear edge, such that the adjacent first sensing electrode patterns 102 are wedged with each other. In one embodiment, the non-linear edge may be a fractal-shaped edge, such as a Koch curve or Minkowski curve type edge. It is noted that the adjacent first sensing electrode patterns 102 shown in FIG. 3 are depicted by different drawing symbols for the purpose of clarity. Moreover, throughout the description, the Koch curve type edge is used for an exemplary embodiment of the non-linear edge only.

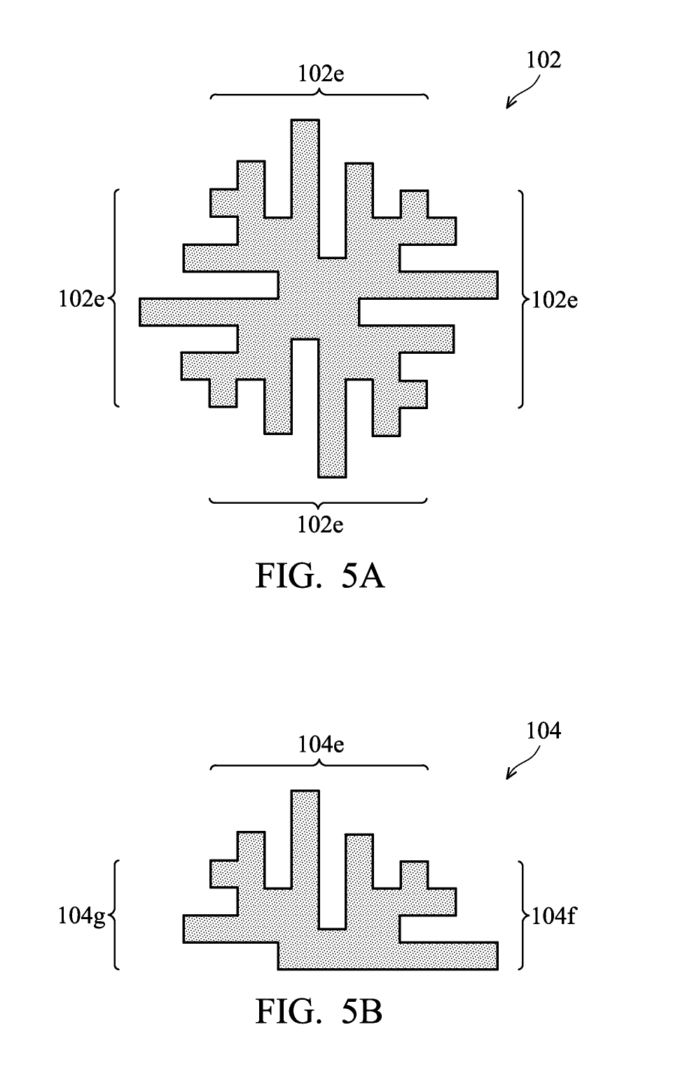

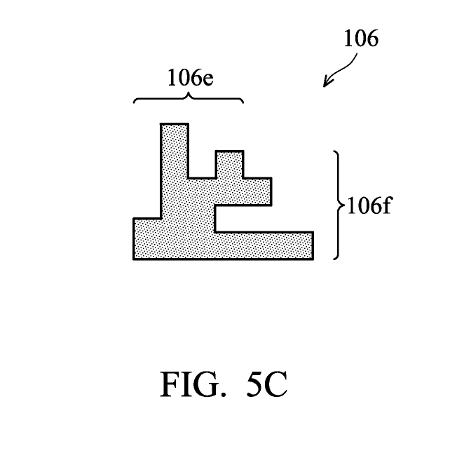

Refer to FIG. 5A, which is a plan view of the first sensing electrode pattern shown in FIG. 3. The first sensing electrode pattern 102 may have four fractal-shaped edge 102e, and each fractal-shaped edge 102e (e.g., Koch curve type edge) are constituted by rectangular protrusions and recesses with alter-laced arrangements. However, in another embodiment, the first sensing electrode pattern 102 may have less than or more than four fractal-shaped edges 102e, and the protrusions and recesses of each fractal-shaped edge 102e may have other shapes, such as a triangular, semi-circular, or other geometric shapes. It can be appreciated that the profile of the central portion 101a of the sensing region 101 of the substrate 100 must be correspondingly varied when the profile of the first sensing electrode pattern 102 is varied.

Referring to FIG. 3 again, the sensing electrodes further comprises a plurality of second sensing electrode patterns 104 electrically insulated from each other and a plurality of third sensing electrode patterns 106 electrically insulated from each other, wherein the second sensing electrode patterns 104 corresponds to the peripheral edge portion 101b (which is shown in FIG. 4) of the sensing region 101 and the third sensing electrode patterns 106 corresponds to the peripheral corner portion 101c (which is shown in FIG. 4) of the sensing region 101. In the embodiment, each second sensing electrode pattern 104 has at least one non-linear edge, such that the adjacent second sensing electrode patterns 104 are wedged with each other and each second sensing electrode pattern 104 is wedged with the adjacent first sensing electrode pattern 102. Moreover, each third sensing electrode pattern 106 has at least one non-linear edge, such that each third sensing electrode pattern 106 is wedged with the adjacent second sensing electrode pattern 104.

Referring to FIGS. 5B and 5C, in which FIG. 5B is a plan view of a second sensing electrode pattern shown in FIG. 3 and FIG. 5C is a plan view of a third sensing electrode pattern shown in FIG. 3. In the embodiment, the second sensing electrode pattern 104 may have three fractal-shaped edges 104e, 104f and 104g, and the third sensing electrode pattern 106 may have two fractal-shaped edges 106e and 106f. The fractal-shaped edges 104e, 104f, 104g, 106e and 106f are similar as the fractal-shaped edge 102e (which is shown in FIG. 5A) and are constituted by rectangular protrusions and recesses with an interlaced arrangement. Accordingly, in some embodiments, each second sensing electrode pattern 104 may have a profile which is the same as a partial profile of the first sensing electrode pattern 102. For example, the second sensing electrode pattern 104 may have a profile which is the same as a half of profile of the first sensing electrode pattern 102. Moreover, each third sensing electrode pattern 106 may have a profile which is the same as a partial profile of the second sensing electrode pattern 104. For example, the third sensing electrode pattern 106 may have a profile which is the same as a half of profile of the second sensing electrode pattern 104.

In another embodiment, the second sensing electrode pattern 104 may have less than or more than three fractal-shaped edges, and the third sensing electrode pattern 106 may have less than or more than two fractal-shaped edges. Moreover, the protrusions and recesses of each fractal-shaped edge may have other shapes, such as a triangular, semi-circular, or other geometry shape. Also, it can be appreciated that the profiles of the peripheral edge portion 101b and peripheral corner portion 101c of the sensing region 101 of the substrate 100 must be correspondingly varied when the profile of the second and third sensing electrode patterns 104 and 106 are varied.

Since the first, second and third sensing electrode patterns 102, 104 and 106 are wedged with each other, input signals from an operation performed by a user can be sensed by at least two sensing electrode patterns. This can facilitate the exterior controlling circuit (not shown) to identify the input location, thereby increasing linearity and sensitivity of the touch sensor device 200.

However, since the sensing areas of the second and third sensing electrode patterns 104 and 106 are less than that of the first sensing electrode pattern 102, the signal intensity sensed from the second and third sensing electrode patterns 104 and 106 is lower than that sensed from the first sensing electrode pattern 102.

In order to increase the signal intensity sensed from the second and third sensing electrode patterns 104 and 106, the sensing electrode layer may further comprise pluralities of extending portions 104a and 106a, as shown in FIG. 3. The plurality of extending portions 104a correspond to at the peripheral edge portion 101b and each one is connected to a corresponding second sensing electrode pattern 104. The plurality of extending portions 106a corresponds to the peripheral corner portion 101c and each one is connected to a corresponding third sensing electrode pattern 106. In one embodiment, the sum of areas of the extending portion 104a and the corresponding second sensing electrode pattern 104 is equal to the area of the first sensing electrode pattern 102. Moreover, the sum of areas of the extending portion 106a and the corresponding third sensing electrode pattern 106 is also equal to the area of the first sensing electrode pattern 102.

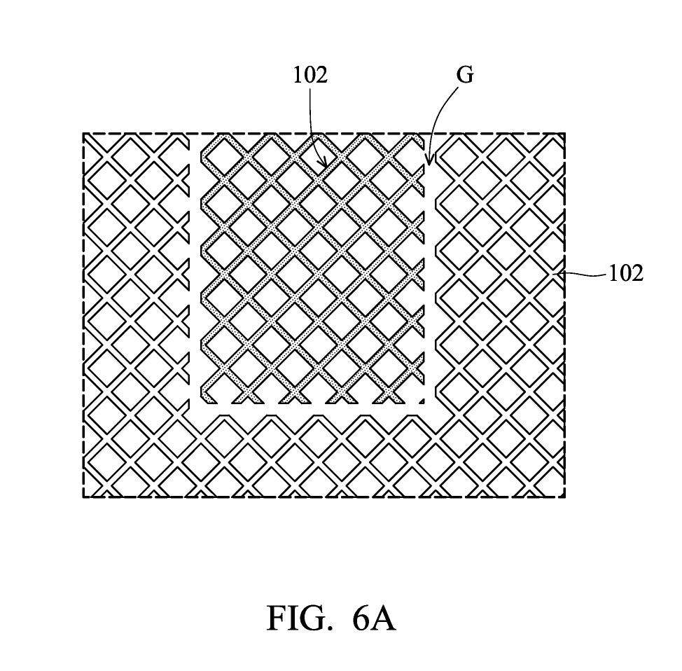

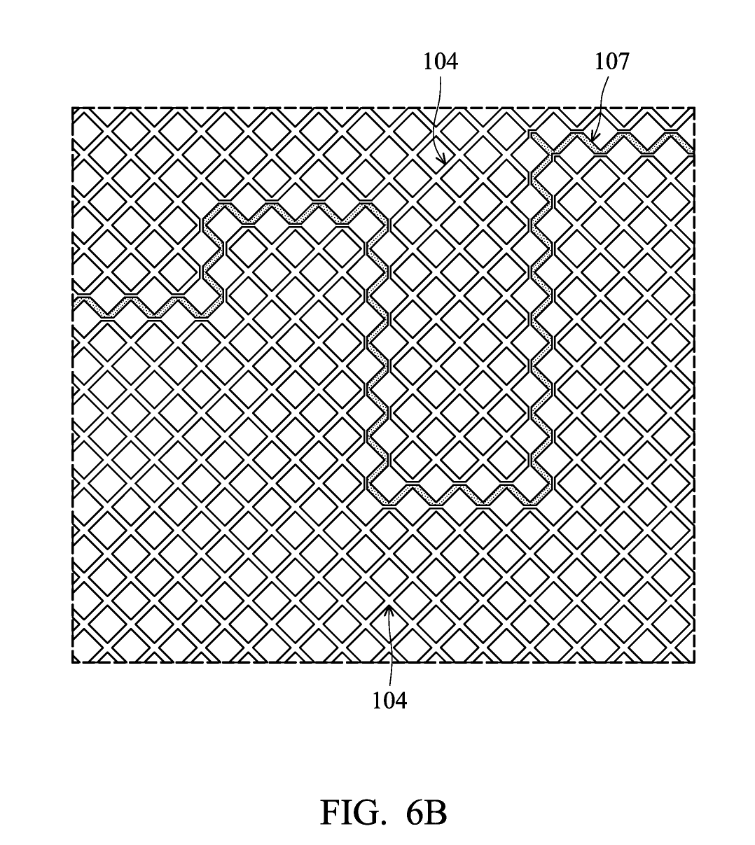

Referring to FIG. 6A, which is an enlarged plan view of the region A shown in FIG. 3. In one embodiment, a groove G is in the sensing electrode layer and between the adjacent first sensing electrode patterns 102, and extends along the fractal-shaped edge 102e (which is shown in FIG. 5A) for electrical insulation between the adjacent first sensing electrode patterns 102. Namely, the groove G may serve as a scribe line for patterning the sensing electrode layer (e.g., a metal mesh layer). In another embodiment, there are at least two parallel grooves G (i.e., dual scribe line) which may be between the adjacent first sensing electrode patterns 102, thereby preventing the sensing electrode patterns from short circuit that is caused by the conductive particles dropping on the single groove during fabrication of the touch sensor device 200. The yield of the touch sensor device 200 is therefore increased.

Also, it is appreciated that at least two parallel grooves may be formed between the adjacent second sensing electrode patterns 104, between each first sensing electrode pattern 102 and the corresponding second sensing electrode pattern 104, and between each third sensing electrode pattern 106 and the corresponding second sensing electrode pattern 104, thereby electrically insulating the first, second and third sensing electrode patterns 102, 104 and 106 from each other.

Referring to FIG. 6B, which is an enlarged plan view of the region B shown in FIG. 3. The sensing electrode layer may further comprise a plurality of traces to electrically connect the corresponding first sensing electrode pattern 102 to the exterior circuit (not shown). Here, in order to simplify the diagram, only one trace 107 is depicted. In one embodiment, the trace 107 extends along one of the fractal-shaped edges of the second sensing electrode pattern 104 to one of the first sensing electrode patterns 102, such that the first sensing electrode pattern 102 is electrically connected to the exterior circuit (not shown). In another embodiment, the trace 107 may extend along one of the fractal-shaped edges of the third sensing electrode pattern 106 to one of the first sensing electrode patterns 102.

Referring to FIG. 6B again, the trace 107 may be formed of a material which is the same as that of the sensing electrode layer. Namely, the first, second and third sensing electrode patterns 102, 104 and 106 and the trace 107 can be defined simultaneously by patterning a metal mesh layer. As a result, the process can be simplified and the manufacturing costs can be reduced, while the visibility of the sensing electrode patterns and the traces can be reduced.

According to the aforementioned embodiments, since the sensing electrode patterns have an interlaced arrangement and have fractal-shaped edges for providing a wedge function, the touch sensor device may be used in a multi-touch operation, and input signals from an operation performed by a user can be sensed by at least two sensing electrode patterns. Accordingly, the linearity of the touch sensor device can be increased without shrinking the sensing electrode pattern, while preventing the routing difficulty from increasing due to the increase of the amount of sensing electrode patterns.

Moreover, the transmittance of the sensing electrode patterns formed of a metal mesh layer is higher than that of the sensing electrode patterns formed of ITO when both of them have the same sheet resistance. Accordingly, the touch sensor device 200 has better optical properties than that of the conventional co-plane single-layer touch sensor device with ITO sensing electrodes.

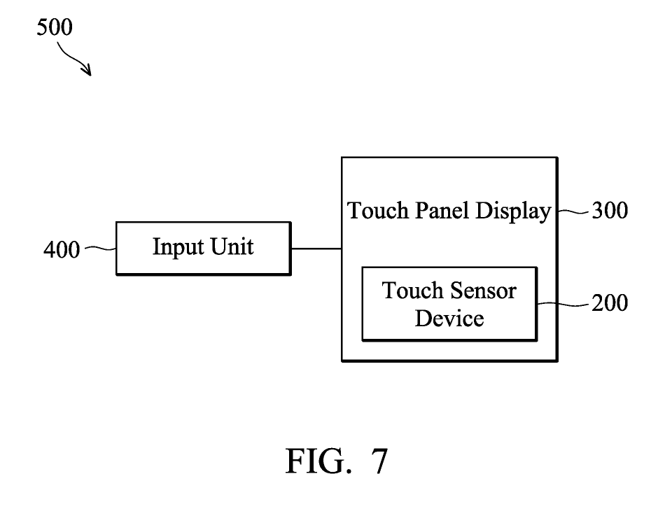

FIG. 7 schematically shows another embodiment of a system for displaying images which, in this case, is implemented as a touch panel display 300 or an electronic device 500 such as a tablet personal computer, a projector, an electronic book, a laptop computer, a mobile phone, a digital camera, a personal digital assistant (PDA), a desktop computer, a television, a car display or a portable DVD player. The described touch sensor device 200 can be incorporated into the touch panel display 300. In some embodiments, the touch sensor device 200 can be incorporated into the electronic device 500. As shown in FIG. 7, the electronic device 500 comprises the touch panel display 300 and an input unit 400. Moreover, the input unit 400 is coupled to the touch panel display 300 and is operative to provide input signals (e.g. image signals) to the touch panel display 300 to generate images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a touch sensor device, comprising:
a substrate having a sensing region, wherein the sensing region comprises a central portion; and
a sensing electrode layer disposed on the substrate in the sensing region and comprising a plurality of first sensing electrode patterns corresponding to the central portion, wherein each first sensing electrode pattern comprises at least one non-linear edge, such that the adjacent first sensing electrode patterns are wedged with each other.

2. The system of claim 1, wherein the non-linear edge is a fractal-shaped edge.

3. The system of claim 2, wherein the fractal-shaped edge comprises a Koch curve or Minkowski curve type edge.

4. The system of claim 2, wherein the sensing region is rectangular and further comprises a plurality of peripheral edge portions and a plurality of peripheral corner portions that surround the central portion, and wherein the sensing electrode layer further comprises:
a plurality of second sensing electrode patterns corresponding to the plurality of peripheral edge portions, wherein each second sensing electrode pattern comprises at least one non-linear edge, such that the adjacent second sensing electrode patterns are wedged with each other and each second sensing electrode pattern is wedged with the adjacent first sensing electrode pattern; and
a plurality of third sensing electrode patterns corresponding to the plurality of peripheral corner portions, wherein each third sensing electrode pattern comprises at least one non-linear edge, such that each third sensing electrode pattern is wedged with the adjacent second sensing electrode pattern

5. The system of claim 4, wherein the sensing electrode layer comprises a patterned metal mesh layer.

6. The system of claim 5, wherein the sensing electrode layer comprises at least two parallel grooves therein, between the adjacent first sensing electrode patterns, between the adjacent second sensing electrode patterns, between each first sensing electrode pattern and a corresponding second sensing electrode pattern, and between each third sensing electrode pattern and a corresponding second sensing electrode pattern, to electrically insulate the pluralities of first, second, and third sensing electrode patterns from each other.

7. The system of claim 5, wherein the sensing electrode layer further comprises at least one trace extending along the fractal-shaped edge of one of the plurality of second or third sensing electrode patterns to one of the plurality of first sensing electrode pattern.

8. The system of claim 4, wherein the sensing electrode layer further comprises a plurality of extending portions corresponding to the pluralities of peripheral edge portions and peripheral corner portions and connecting to a corresponding second sensing electrode pattern or a corresponding third sensing electrode pattern, respectively, such that the sum of the areas of each extending portion and the corresponding second or third sensing electrode pattern equal to the area of the first sensing electrode pattern.

9. The system of claim 4, wherein each second sensing electrode pattern has a profile which is the same as a partial profile of each first sensing electrode pattern.

10. The system of claim 9, wherein each third sensing electrode pattern has a profile which is the same as a partial profile of each second sensing electrode pattern.

11. The system as claimed in claim 1, further comprising:
a touch panel display comprising the touch sensor device; and
an input unit coupled to the touch panel display and operative to provide input signals to the touch panel display, such that the touch panel display displays images.

12. The system of claim 11, wherein the system comprises an electronic device comprising the touch panel display.

13. The system of claim 12, wherein the electronic device is a tablet personal computer, a projector, an electronic book, a laptop computer, a mobile phone, a digital camera, a personal digital assistant, a desktop computer, a television, a car display or a portable DVD player.
